(19) United States
(12) Patent Application Publication
(10) Pub. No.: US 2007/0063629 A1
(43) Pub. Date: Mar. 22, 2007

(54) Field emitters and devices

(76) Inventor: Richard Allan Tuck, Slough (GB)

Correspondence Address: BARNES & THORNBURG LLP, P.O. BOX 2786, CHICAGO, IL, 60690-2786, US

(21) Appl. No.: 10/575,822

(22) PCT Filed: Oct. 12, 2004
(86) PCT No.: PCT/EP04/52509

§ 371 Date: Apr. 12, 2006

(30) Foreign Application Priority Data
Oct. 13, 2003 (GB) 0323942.3

(51) Int. Cl. H01J 1/62; H01J 63/04

(52) U.S. Cl. 313/311; 313/310; 313/495; 313/497

(57) ABSTRACT

A Hop-FED structure has emitter areas (301, 302) on a substrate (300), and a hop-plate (303) disposed over the substrate (300) and emitter areas (301, 302) with a surface of the hop-plate (303) opposing the substrate (300) and emitter areas (301, 302). An electrically conductive layer (401) is formed on the surface of the hopplate (303), to dissipate charge build-up.

This invention relates to field emission materials and devices, and is concerned particularly but not exclusively with methods of manufacturing addressable field electron emission cathode arrays. Preferred embodiments of the present invention aim to provide improved designs with improved uniformity and reliability.

It has become clear to those skilled in the art that the key to practical field emission devices, particularly displays, lies in arrangements that permit the control of the emitted current with low voltages. Until recently, the majority of the art in this field related to tip-based emitters—that is, structures that utilise atomically sharp micro-tips as the field emitting source.

There is considerable prior art relating to tip-based emitters. The main objective of workers in that art has been to place an electrode with an aperture (the gate) less than 1 micron away from each single emitting tip, so that the required high fields can by achieved using applied potentials of 100V or less—these emitters are termed gated arrays. The first practical realisation of this was described by C A Spindt, working at Stanford Research Institute in California (J. Appl. Phys. 39, 7, pp 3504-3505, (1968)). Spindt's arrays used molybdenum emitting tips which were produced, using a self masking technique, by vacuum evaporation of metal into cylindrical depressions in a SiO₂ layer on a Si substrate. Many variants and improvements on the basic Spindt technology are described in the scientific and patent literature.

In about 1985, it was discovered that thin films of diamond could be grown on heated substrates from a hydrogen-methane atmosphere, to provide broad-area field emitters. Much later (1995) Tuck, Taylor and Latham (GB 2 304 989) described an improved broad-area emitter. Work in this area, which includes carbon and other nanotube layers, is now very fashionable and there is a building body of art in both the patent and scientific literature.

The best examples of such broad-area emitters can produce usable electric currents at fields less than 10 V/micron. In the context of this specification, a broad-area field emitter is any material including carbon and other nanotube layers that by virtue of its composition, micro-structure, work function or other property emits useable electronic currents at macroscopic electrical fields that might be reasonably generated at a planar or near-planar surface—that is, without the use of atomically sharp micro-tips as emitting sites.

A problem with broad-area emitters is that the exact location of the emitter or emitters within the emitter cell formed by the aperture in the gate electrode, the gate insulating layer, the cathode track and the coating of emitter, is unpredictable. This in contrast to tip-based emitters, which will typically be close to the centre. The extraction field is highest near the perimeter of the cell and, as a result, the electrons rarely originate from the centre of the cell so that their kinetic energies have a large radial component. It is rare for the combined effect of the modest number of sources from the multiple cells in a pixel to be a symmetrical, which results in each pixel exciting a different shaped region on the phosphor coated anode. Even with the same current per pixel, the visual effect of this is very visible fixed pattern noise.

The high radial component of kinetic energy also reduces the effectiveness of conventional electron optical focusing schemes, which in turn limits pixel and sub-pixel sizes—the problem is particularly serious with colour displays where electron cross-talk between sub-pixels affects colour purity.

Recently, Van der Vaart et al (WO 03/041039 A2) described a field emission display which has a perforated insulating plate with an upper conducting layer (the hop-electrode) set to a positive voltage placed between the cathode plane and the anode. Within this so-called Hop-Plate, secondary electron hopping transport is used to homogenise the electrons and re-emit them as secondary electrons with energies around 5 eV. The hop-plate is normally made of glass having a coefficient of expansion matched to the rest of the display. The channels are usually formed by powder blasting. This electron hopping transport was first described by Van Gorkorn in U.S. Pat. No. 5,270,611 together with devices using the technique. A display based upon this principle called Zeus was well described in Philips Journal of Research Vol 50, Nos. 3/4 (1996).

Because the hopping is a chaotic process, there is no correlation between the location at which an electron leaves the pixel, the direction it travels within the channel and the position of re-emission of the low energy secondary electron. As a result, there are effectively as many emitting sites per pixel as there are electrons in the pulse, leading to excellent intra-pixel uniformity. Provided the correct voltage is applied to the hop-electrode, the channel has a transmission factor of unity—i.e. as many electrons leave the exit as arrive at the entrance.

It is in this area of Hop-FED displays and other devices using the technology that preferred embodiments of the present invention make a contribution to the art.

According to one aspect of the present invention, there is provided a Hop-ED structure comprising:
a. a substrate;
b. emitter areas on said substrate;
c. a hop-plate disposed over said substrate and emitter areas with a surface of the hop-plate opposing said substrate and emitter areas; and
d. an electrically conductive layer formed on said surface of the hop-plate.

Preferably, said surface is formed with projections that space the remainder of the hop-plate from said substrate and emitter areas.

Preferably, said projections are formed as pillars or ribs.

Said electrically conductive layer may be provided on said projections.

Said electrically conductive layer may not be provided on said projections.

Said electrically conductive layer may be of a material of high electrical resistivity.

Said material may have a surface resistivity in the range 10⁷ to 10¹¹ ohms per square.

Said material may have a surface resistivity in the range 10⁸ to 10¹⁰ ohms per square.

Said material may have a surface resistivity of substantially 10⁹ ohms per square.

Said material may be selected from the group comprising amorphous silicon and silver doped silica.

Said electrically conductive layer may extend partially within the channels of the hop-plate.

Said electrically conductive layer may be connected to means for holding said layer at a predetermined potential.

In another aspect, the invention provides a Hop-FED structure comprising:
a. a cathode with emitter areas;
b. an anode arranged to receive electrons emitted from the cathode;
c. a hop-plate disposed between the cathode and anode;
d. spacer means arranged to provide a space between said cathode and anode; and
e. gettering material disposed in said space.

Preferably, said spacer means comprises projections provided on one or both faces of said hop-plate.

Such a Hop-FED structure may further comprise a flue-plate between said hop-plate and anode.

Said spacer means may comprise projections provided on one or both faces of said flue-plate.

Preferably, said spacer means are formed as pillars or ribs on said hop-plate and/or flue-plate.

Preferably, said gettering material forms a distributed getter.

Said gettering material may comprise a non-evaporated getter.

Said gettering material may comprise an alloy containing at least one Group IV metal.

Preferably, the structure is sealed by a glass-frit seal that is spaced from said gettering material, and the structure further comprises a conductive member that is compatible with said glass-frit and extends from outside the structure, through said glass-frit seal and to said gettering material, to which it is electrically connected.

In another aspect, the invention provides a method of manufacturing a hop-plate for a Hop-FED structure, the method comprising the steps of,
a. applying an electrically conductive layer to a surface of a main body,
b. applying a sacrificial layer to said electrically conductive layer,
c. applying a protective layer with apertures to said sacrificial layer,
d. eroding portions of said sacrificial layer, electrically conductive layer and main body through said apertures so as to form channels through said main body at the locations of said apertures, said protective layer otherwise protecting said sacrificial layer, electrically conductive layer and main body from erosion;
e. applying a secondary emission layer to said sacrificial layer and main body, including said channels; and
f. removing said sacrificial layer with contiguous portions of said secondary emission layer to expose said electrically conductive layer and said channels coated with said secondary emission layer.

Such a Hop-FED structure Preferably, in accordance with any of the preceding aspects of the invention.

Said sacrificial layer may comprise vacuum-evaporated or sputter-coated aluminium.

Said protective layer may comprise a photoresist material.

Preferably, said erosion step is carried out by powder blasting.

Said blasting may utilise alumina abrasive media.

Said secondary emission layer may comprise alumina.

A method as above may further comprise the step of applying a hop-electrode to said main body.

In another aspect, the invention provides a method of manufacturing a Hop-FED structure with a gettering material as above, the method comprising the steps of:
a. applying a protective layer with apertures to a surface of a main body of a hop-plate or flue-plate;

b. eroding portions of said main body through said apertures, said protective layer otherwise protecting said main body from erosion; and

c. removing said protective layer to define at locations under said protective layer projections to serve as said spacer means.

Preferably, said protective layer comprises a photoresist material.

Preferably, said erosion step is carried out by powder blasting.

Said blasting may utilise alumina abrasive media.

Said erosion step may be carried out by etching.

In another aspect, the invention provides a method of manufacturing a Hop-FED structure with a gettering material as above, the method comprising the steps of applying a metal film in a pattern to a main body of a hop-plate or flue-plate and electroplating said metal film to define projections that serve as said spacer means.

Preferably, said metal film is applied by sputter coating.

In another aspect, the invention provides a method of manufacturing a Hop-FED structure with a gettering material as above, the method comprising the steps of applying multiple layers of glass frit to a main body of a hop-plate or flue-plate to define projections that serve as said spacer means.

Preferably, said layers of glass frit are applied by a printing process.

Preferably, said main body is of glass.

For a better understanding of the invention, and to show how embodiments of the same may be carried into effect, reference will now be made, by way of example, to the accompanying diagrammatic drawings, in which:

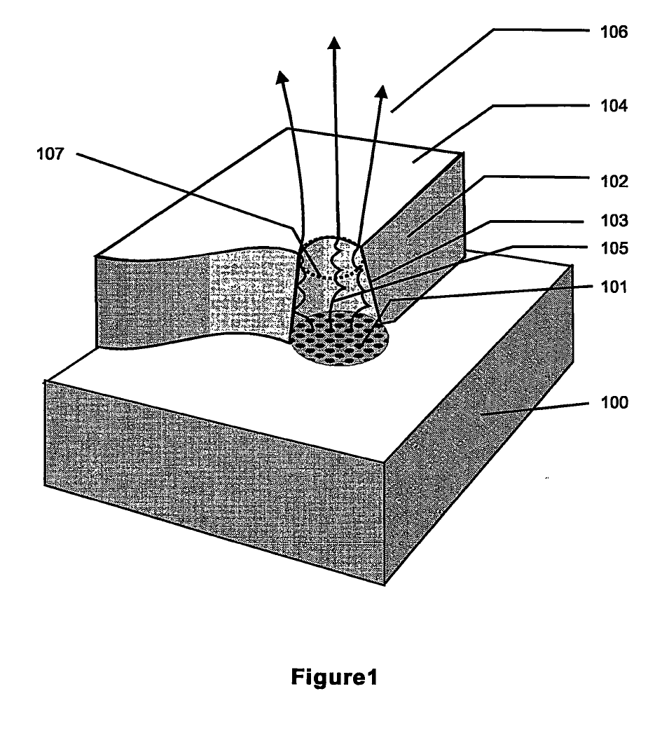

FIG. 1 illustrates the basic concept of a Hop-FED;

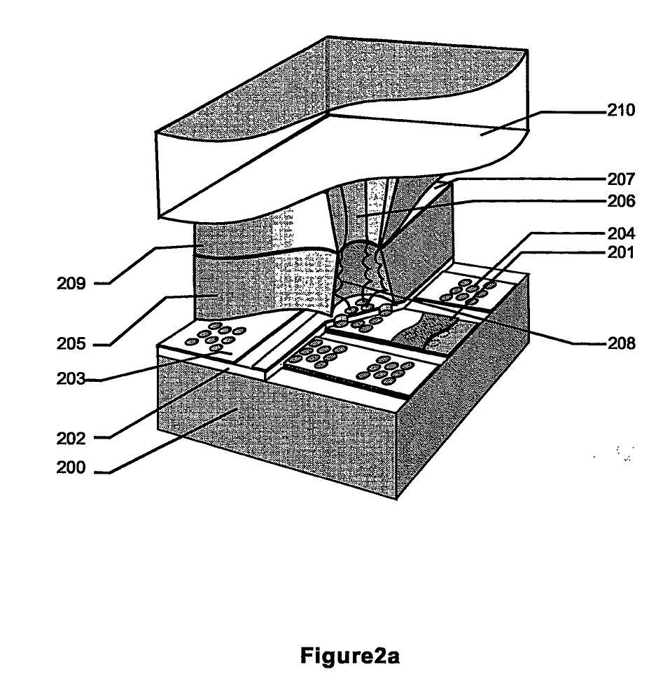

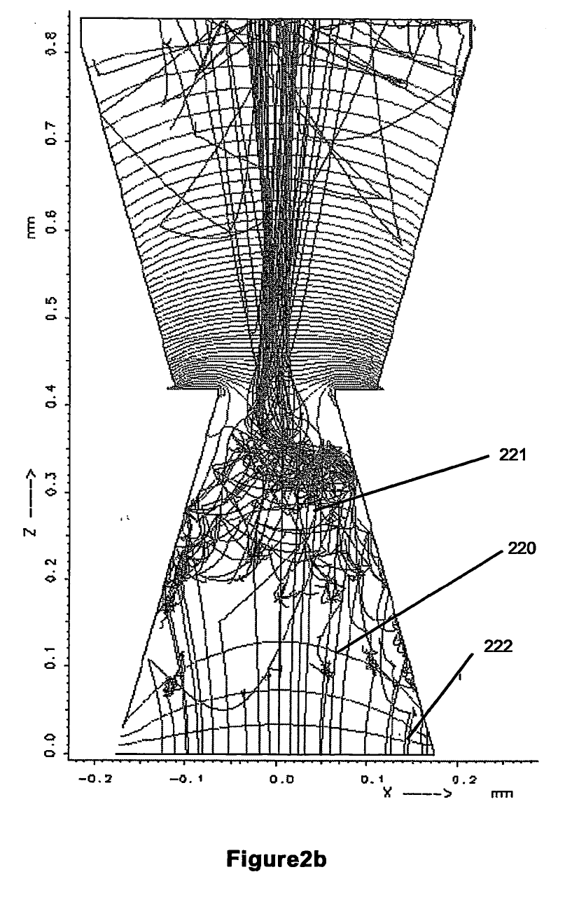

FIG. 2a shows fuller details of a Hop-FED;

FIG. 2b shows a Monte Carlo electron trajectory simulation of a Hop-FED;

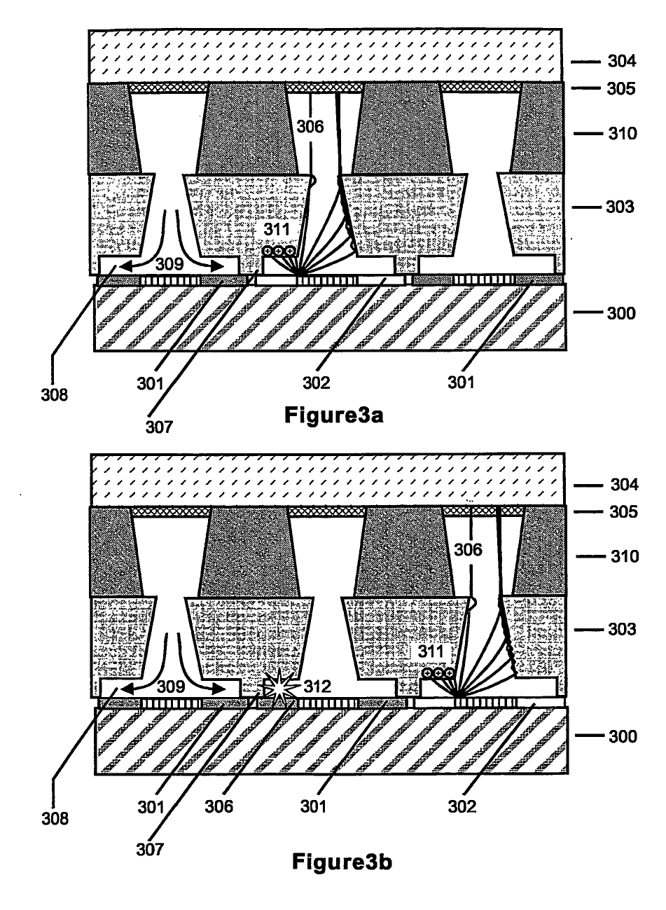

FIGS. 3a and 3b show a Hop-Fed with pillars or ribs, and charging problems that can occur;

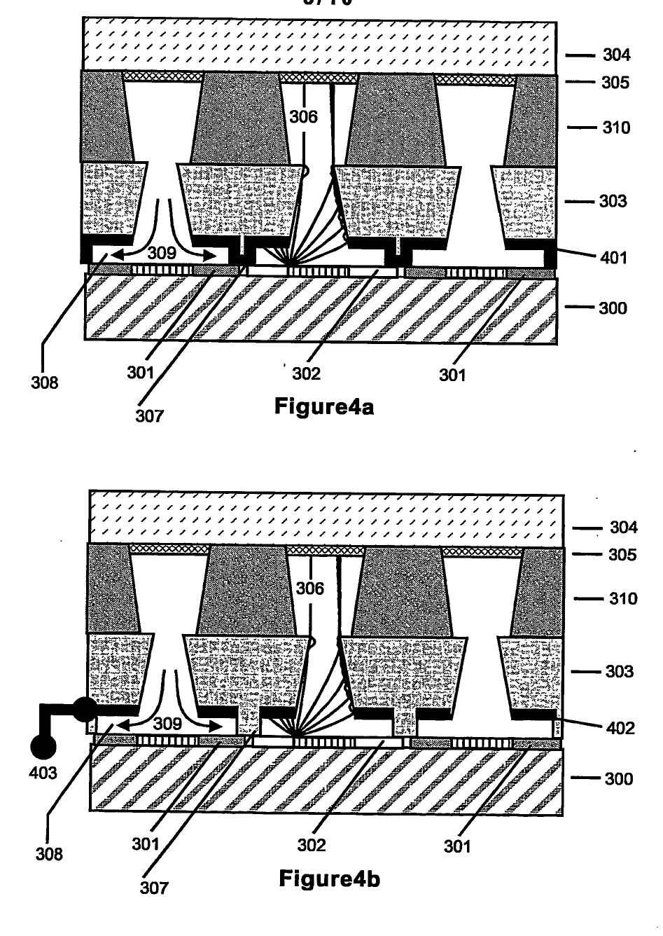

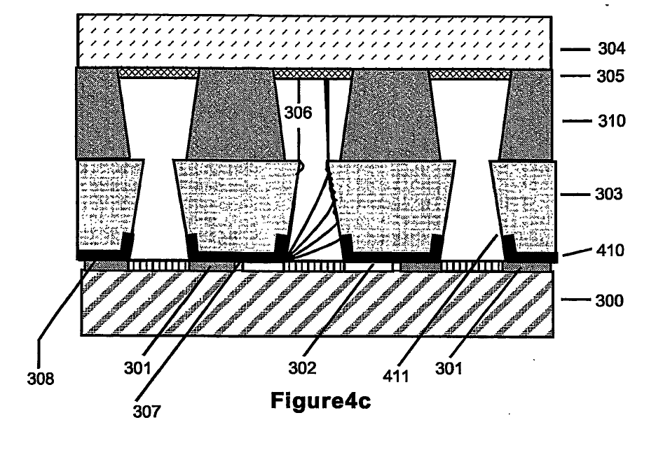

FIGS. 4a and 4b are views similar to FIGS. 3a and 3b, but showing the use of resistive layers to overcome charging problems;

FIG. 4c is a view similar to FIG. 4a, but without ribs or pillars;

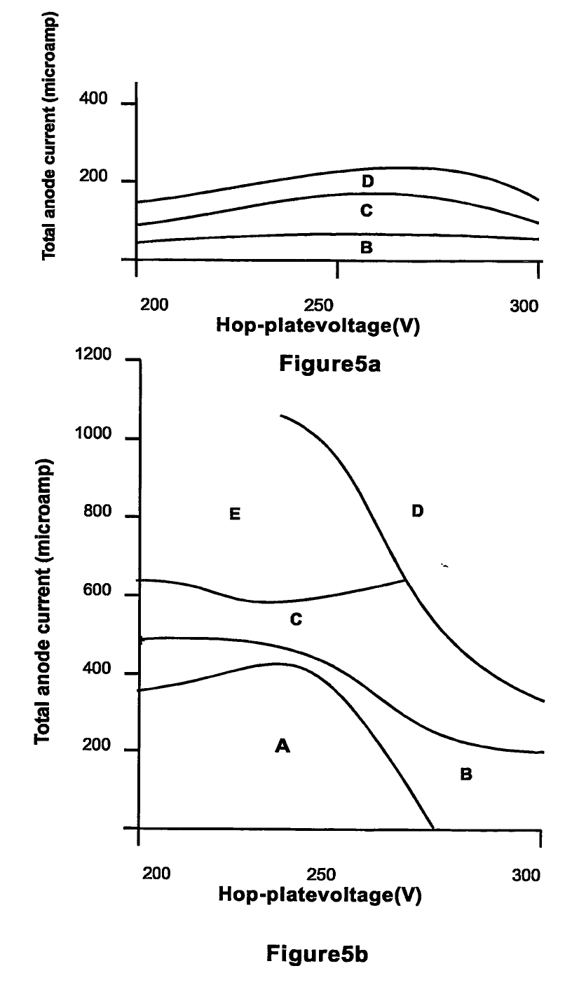

FIGS. 5a and 5b are graphs to demonstrate the effectiveness of the embodiments of FIG. 4, as compared to structures without the resistive layers of FIG. 4;

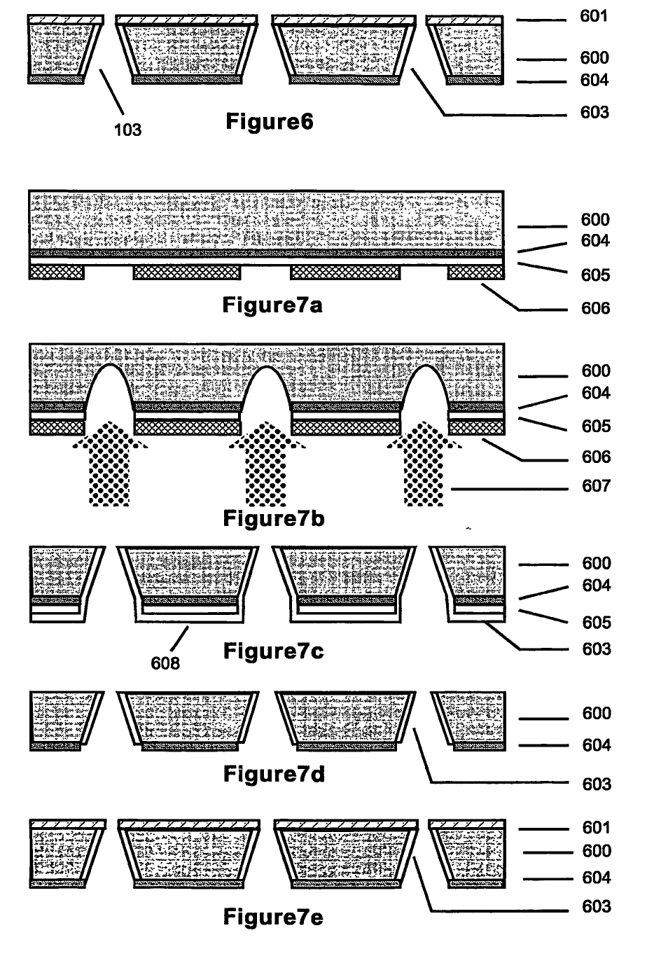

FIG. 6 illustrates a final structure required for a simple spaced hop-plate (pillars omitted for simplicity);

FIGS. 7a to 7e show an exemplary process flow to create the structure of FIG. 6;

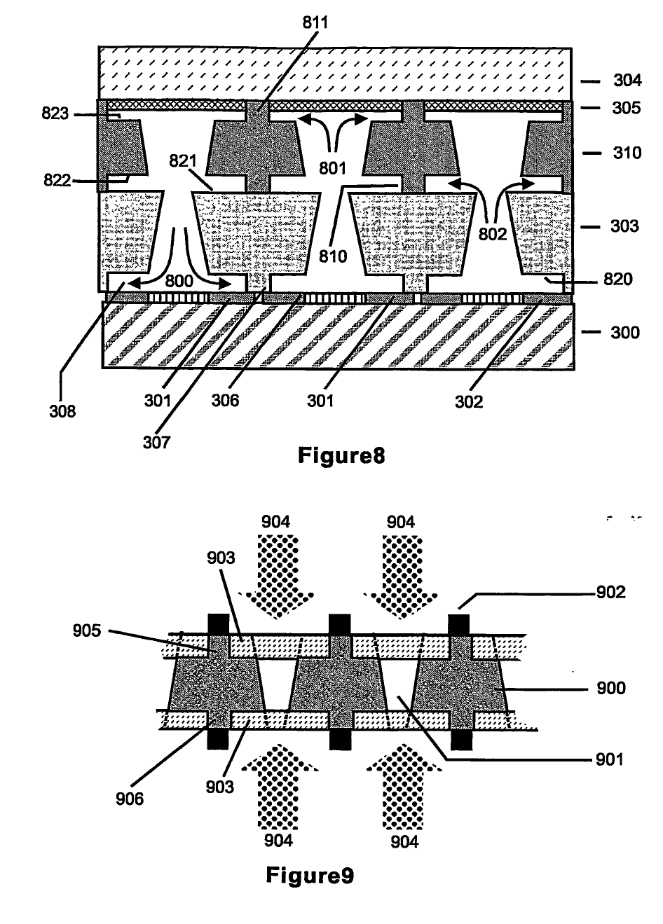

FIG. 8 illustrates a Hop-FED with additional spacer pillars or ribs to provide surface areas for distributing a getter film;

FIG. 9 shows one example of a method of fabricating pillars or ribs;

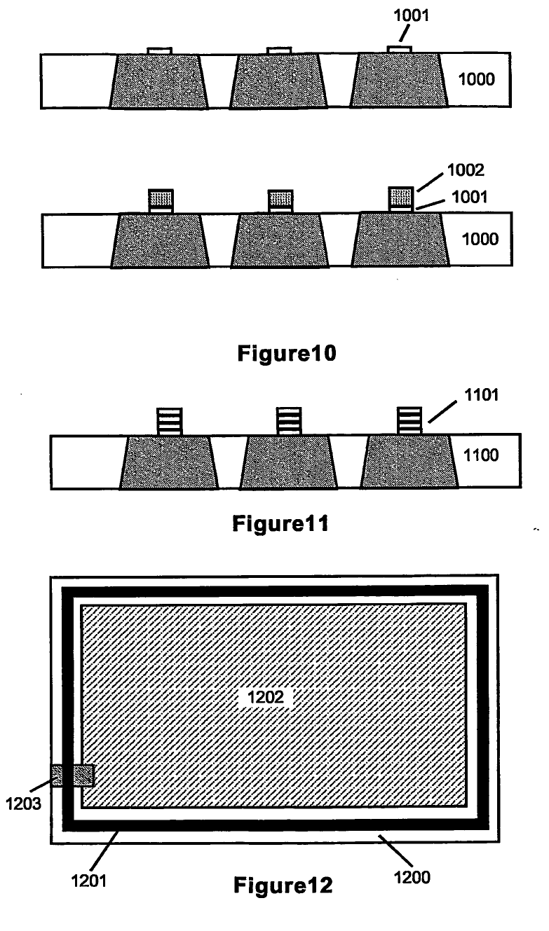

FIG. 10 shows an alternative method of creating pillars or ribs;

FIG. 11 shows another method of creating pillars or ribs;

FIG. 12 shows an arrangement where a hop-plate 1200 has a frit seal ring impinging upon it, gettering material formed so as to avoid the frit seal, and a frit-compatible leadthrough.

In the figures, like reference numerals denote like or corresponding parts.

In the context of this specification, a “Hop-FED structure” comprises an insulating plate (the hop-plate) that is perforated to define channels through which electrons pass, is placed between cathode and anode, and has a conducting layer (the hop-electrode) on the anode side.

FIG. 1 illustrates the basic concept of a Hop-FED. FED cathode plane 100 has an array of emitter cells 101 per pixel set within the entrance diameter of a hop-channel 103 formed in a hop-plate 102. Electrons 105 strike the channel walls and hop towards a hop-electrode 104 at a positive potential. The majority of the secondary electrons 106 are re-emitted from the channel wall near the top, forming a ring-shaped emitting area 107.

FIG. 2 shows the full Hop-FED concept as described by Van der Vaart et al which uses a second, so-called flue-plate 209, where electrons are accelerated towards the anode. Together the hop-plate 205 and the flue-plate 209 form a spacer system to support the cathode and anode against atmospheric pressure. In more detail, the basic Hop-FED structure is as follows. On substrate 200 there is a conventional broad-area FED structure (see for example the applicants patent GB 2 330 687) with gate electrodes 203 and with emitter layer on a conducting track 201 exposed through emitter cells 204. The gate and emitter track are insulated from each other by dielectric layer 202.

In this embodiment, a hop-plate 205 sits directly upon the FED cathode plane with hop-electrode 207. The flue-plate 209 sits upon the hop-plate 205 and anode plate 210 completes the sandwich structure. The electrons are now confined to channel 206 where, in the hop-plate portion, they undergo homogenisation by hopping 208 and in the flue-plate channel they are accelerated to high voltage. Both the hop-plate and the flue-plate have various functional coatings applied to them.

Whilst the concept of the Hop-FED is attractive, some very real problems appear when one tries to build and operate one. The first of these are illustrated in FIG. 2b, which is a Monte Carlo electron trajectory simulation of such a device taken from Visser et a Society for Information Display SID '03 Digest Paper 18.4. The model shows a hop-plate flue-plate combination with electron trajectories 221 and equipotentials 220. A stated advantage of this design is to reduce the electric field at the surface of the FED and so reduce the chance of arc damage. However, if one looks at the simulation, the equipotentials crowding together in the region 222 closest to the cathode surface show that, in fact, a high field exists near the cathode surface.

One potential solution to this problem is illustrated in FIG. 3a, which shows a substrate 300 with field emitting structures in tracks 301 and 302, a hop-plate 303, flue-plate 310, phosphor layer 305 and anode glass 304. The hop-plate is spaced off of the cathode by pillars or ribs 307 which both reduce the field at the cathode surface and also allow outgassing products 309 to be pumped away through gap 308. Methods of forming such pillars or ribs are described below with reference to FIG. 9. However, although this reduces the exposure of the cathode to the high field at the neck of the hop-channel, it presents another problem in that, because of the high radial energy of electrons in FEDs (particularly those with broad-area emitters), emitted electrons 306 from the margins of the emitter cell groups can strike the underside of the hop-plate, causing it to charge 311. Charging occurs during the period gate 302 is positive with respect to both the emitter and the gates on either side 301. As the next gate is addressed (FIG. 3b) the gate beneath the charged region drops in potential and an increased field appears between the charged region and the gate and a discharge 312 may occur leading to unstable operation and damage to the FED cathode plane.

FIG. 4a (wherein like elements are numbered as in previous figures) shows a solution to this problem. A conducting layer 401 is applied to the underside of the hop-plate 303 and pillars 307. To prevent the conducting layer short-circuiting all gate tracks together, a highly resistive layer is used. This is sufficiently conductive to dissipate any charge build-up but sufficiently resistive that it does not draw excessive current from the gate driver electronics. A surface resistivity of 10⁹ ohms per square may be suitable. Suitable films are sputtered amorphous silicon and a printed silver doped silica layer as described in our co-pending application GB 03 22360.9.

FIG. 4b (wherein like elements are numbered as in previous figures) shows an alternative approach where the pillars 307 are left uncoated, and hence are insulating, and a conductive film 402 is applied to the underside of the hop-plate 303 only. It is now less import that the film be resistive and its potential may be set by connection to an external power supply 403.

FIG. 4c shows yet another approach where the hop-plate 303 does not have insulating pillars but sits directly on the surface of the gates. In this case, film 410 has a high surface resistivity of ˜10⁹ ohms per square but the high field region, which would be at the entrance to the hop-channel, is moved away from the gate surface by allowing film 410 to enter the channel by typically 100 microns 411. Suitable films are sputtered amorphous silicon where the penetration is controlled by choice of sputtering pressure or printed silver doped silica layer that has been allowed to flow into the channel by controlling printing conditions.

Although two examples of resistive films have been given, others may be substituted by those skilled in the art.

FIGS. 5a and 5b demonstrate the effectiveness of the embodiments of FIG. 4. In this case, the experimental data compares the performance of a hop-plate with no resistive layer (FIG. 5a) with one having a silver doped silica layer that has been allowed to penetrate the hop-channels (FIG. 5b). The data, which shows total anode current against hop-electrode voltage, is for a 5.7 inch diagonal quarter VGA Hop-FED. Observation of the performance of the device, when driven to peak white, shows a number of regions.

| Region | Observation |
|---|---|
| A | No arcing |
| B | A few arcs diminishing with time |
| C | Continuous light arcing |
| D | Continuous heavy arcing |
| E | Not explored |

It can be seen clearly in FIG. 5a that the hop-plate with no resistive layer does not operate stably whereas the one with the resistive layer in FIG. 5b has a large region “A” where stable operation occurs.

In order to achieve long-term operation, it is normal to coat the inner region of the hop-channel with a material that has both a high secondary emission yield and is stable under electron bombardment. Suitable materials are MgO or Al₂O₃ but others may be used. These layers are typically sputtered or electron beam evaporated. For a simple spaced hop-plate, the final structure required is that in FIG. 6 (pillars omitted for simplicity). Because of the funnel shaped nature of the hop-channel 103, the key problem is how to get the resistive or conducting layer 604 onto the under surface of the hop-plate 600 without contaminating the secondary emission coating 603. Because of the more favourable geometry of the tapered channel from above, the conducting hop-electrode 601 can usually be applied later by some line-of-sight process, such as vacuum evaporation, without contaminating the secondary emitting layer.

FIGS. 7a to 7e show an exemplary process flow to create a desired structure; those skilled in the art may create others without departing from the teachings of this document. Note that, whilst in the case illustrated, the hop-electrode layer 601 is applied later, it could equally be applied before powder blasting is commenced and protected either by jigging or a resist layer.

FIG. 7a shows a preliminary stage in which we have glass 600, resistive layer 604 deposited as previously described and a sacrificial layer 605, such as vacuum-evaporated or sputter-coated aluminium. A photoresist layer 606 has been applied, exposed and patterned to define the entrance apertures of the hop-channels.

Moving now to FIG. 7b, powder blasting with, e.g. alumina abrasive media 607, is used to remove material to form the conical apertures.

FIG. 7c shows the completed structure with resist stripped off and the secondary emission layer 603—say alumina—coated inside the hop-channels and unavoidably over the whole lower side of the plate.

Moving now to FIG. 7d the sacrificial layer 605 is removed with say hydrochloric acid and, in the process, the unwanted portions of the secondary emission layer 608 are removed by a lift-off process.

In FIG. 7e the hop-electrode 601 has now been added to complete the process.

We now move to another improvement to the Hop-FED art—this concerns vacuum design. Returning to FIG. 2 we see that, although the electrons within each pixel or sub-pixel are totally confined, avoiding any inter-pixel cross-talk, they are, for all practical purposes, cut off from each other and the pump tube used to evacuate the device. Van der Vaart et al (WO 03/041039 A2) partially addresses this problem and describes pumping channel systems to connect the hop-channels. However, they do not address gettering, which is the other key aspect of obtaining and maintaining a good vacuum in sealed-off devices. By a getter we mean a chemically reactive material enclosed within a vacuum device to adsorb species out-gassed from the surfaces of the device throughout its life. These materials are divided into two broad classes: evaporated getter films, typically barium, and non-evaporated getters (NEGs), often based upon metals or alloys from Group IV of the periodic table. Whilst evaporated getters produce a one-time active surface, NEGs produce an active surface by sorbing gasses into their bulk to leave a new clean and reactive surface. The best materials activate at temperatures compatible with the bakeout used during electron tube processing, so no additional heating is required.

NEGs are typically introduced into vacuum devices in the form of pellets or metal tape with the powdered gettering material swaged into the surface. However, recently work has been reported on directly applying these materials onto device surfaces by, for example, sputter coating—e.g. Prodromides describes a sputtered Ti:Zr:V ternary alloy (Thèse No. 2652, 2002, Ecole Polytechnique Fédérale de Lausanne) This document can be conveniently be downloaded from the CERN Document Server at:
http://cdsweb.cern.ch/search.py?p=TiZrV+non-evaporable+getter&f=&c=
   where a number of other documents on the topic also reside. Kim, Y. C. et al describe a sputtered Ti:Zr:Cr ternary alloy (IVMC 2002 Digest Paper PM.03).

In the context of this specification, a “distributed” getter is a getter that is distributed over a predetermined region, in contrast to a getter that is applied indiscriminately over an available area.

Whilst the simple conceptual Hop-FED of FIG. 2 is not ideal from a gettering perspective, the Hop-FED is in fact more suited to distributed gettering than a standard FED. It can be seen in FIG. 8 that by adding spacer pillars or ribs at one or more of the locations 307, 810 and 811, large areas of surface suitable for distributing a NEG film are made available. The pillars or ribs are typically 100 microns in height. Perhaps the most simple of these options is forming the hop-electrode out of a conducting NEG layer.

The fabrication of the ribs can be by a variety of methods. FIG. 9 shows one example, following the powder blasting of hop-channels 901 in glass sheet 900 as previously described. One or more new layers of photoresist can be applied and patterned 902 and a second/third blasting operation 904 undertaken to remove material 903 to leave pillars or ribs 905 or 906. In some cases, during these subsequent operations, the surface micro-cracking associated with powder blasting becomes an issue, and in that case wet etching in hydrofluoric acid or reactive ion etch are also options—see for example Steingoetter et al (2003) (Proc. of SPIE Vol 4984 p 235). In any of these cases, during the pillar or rib formation, there will be some enlargement of the diameter of hop-channel. In order to compensate for this, the initial blasting is adjusted to produce undersize channels that will later be enlarged by erosion from the pillar or rib formation process.

FIG. 10 shows an alternative method of creating pillars or ribs in which a metal film e.g. sputter-coated is patterned 1001 on the hop-plate 1000 and then electroplated up the required height 1002.

FIG. 11 shows another method where the hop-plate 1100 has pillars or ribs built from multiple layers of screen-printed glass frit, such techniques being common in plasma display fabrication. The layers are dried and fired between applications.

Returning now to FIG. 8 it can be seen that, depending on the arrangement of spacer pillars or ribs there are four potential locations for distributed NEG layers in a Hop-FED, namely surfaces 820, 821, 822 and 823. Not all of these need be used—in fact, substituting a NEG material for the hop-electrode may be all that is required.

However, no known NEG materials are compatible with frit seals, so a separate lead-out material is likely to be required. FIG. 12 shows such an arrangement where, for example, a hop-plate 1200 has a frit seal ring 1201 impinging upon it, NEG material 1202 formed so as to avoid the frit seal and frit compatible leadthrough (e.g. chromium) 1203. Similar considerations may apply to other locations if external driven voltages need to be applied.

In this specification, the verb “comprise” has its normal dictionary meaning, to denote non-exclusive inclusion. That is, use of the word “comprise” (or any of its derivatives) to include one feature or more, does not exclude the possibility of also including further features.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

The reader's attention is directed to all and any priority documents identified in connection with this application and to all and any papers and documents that are filed concurrently with or previous to this specification in connection with this application and which are open to public inspection with this specification, and the contents of all such papers and documents are incorporated herein by reference.

1. A Hop-FED structure comprising:
a. a substrate;
b. emitter areas on said substrate;
c. a hop-plate disposed over said substrate and emitter areas with a surface of the hop-plate opposing said substrate and emitter areas; and
d. an electrically conductive layer formed on said surface of the hop-plate.

2. A Hop-FED structure according to claim 1, wherein said surface is formed with projections that space the remainder of the hop-plate from said substrate and emitter areas.

3. A Hop-FED structure according to claim 2, wherein said projections are formed as pillars or ribs.

4. A Hop-FED structure according to claim 2, wherein said electrically conductive layer is provided on said projections.

5. A Hop-FED structure according to claim 2, wherein said electrically conductive layer is not provided on said projections.

6. A Hop-FED structure according to claim 1, wherein said electrically conductive layer is of a material of high electrical resistivity.

7. A Hop-FED structure according to claim 6, wherein said material has a surface resistivity in the range 10⁷ to 10¹¹ ohms per square.

8. A Hop-FED structure according to claim 7, wherein said material has a surface resistivity in the range 10⁸ to 10¹⁰ ohms per square.

9. A Hop-FED structure according to claim 8, wherein said material has a surface resistivity of substantially 10⁹ ohms per square.

10. A Hop-FED structure according to claim 6, wherein said material is selected from the group comprising amorphous silicon and silver doped silica.

11. A Hop-FED structure according to claim 1, wherein said electrically conductive layer extends partially within the channels of the hop-plate.

12. A Hop-FED structure according to claim 1, wherein said electrically conductive layer is connected to means for holding said layer at a predetermined potential.

13. (canceled)

14. A Hop-FED structure comprising:
a. a cathode with emitter areas;
b. an anode arranged to receive electrons emitted from the cathode;
c. a hop-plate disposed between the cathode and anode;
d. spacer means arranged to provide a space between said cathode and anode; and
e. gettering material disposed in said space.

15. A Hop-FED structure according to claim 14, wherein said spacer means comprises projections provided on one or both faces of said hop-plate.

16. A Hop-FED structure according to claim 14, further comprising a flue-plate between said hop-plate and anode.

17. A Hop-FED structure according to claim 16, wherein said spacer means comprises projections provided on one or both faces of said flue-plate.

18. A Hop-FED structure according to claim 15, wherein said spacer means are formed as pillars or ribs on said hop-plate and/or flue-plate.

19. A Hop-FED structure according to claim 14, wherein said gettering material forms a distributed getter.

20. A Hop-FED structure according to claim 14, wherein said gettering material comprises a non-evaporated getter.

21. A Hop-FED structure according to claim 20, wherein said gettering material comprises an alloy containing at least one Group IV metal.

22. (canceled)

23. A Hop-FED structure according to claim 14, wherein the structure is sealed by a glass-frit seal that is spaced from said gettering material, and the structure further comprises a conductive member that is compatible with said glass-frit and extends from outside the structure, through said glass-frit seal and to said gettering material, to which it is electrically connected.

24-43. (canceled)

44. A Hop-FED structure comprising:
a. a cathode having a substrate and emitter areas on said substrate;
b. an anode arranged to receive electrons emitted from the cathode;
c. a hop-plate disposed over said substrate and emitter areas, between the cathode and anode, with a surface of the hop-plate opposing said substrate and emitter areas;
d. an electrically conductive layer formed on said surface of the hop-plate.
e. spacer means arranged to provide a space between said cathode and anode; and
f. gettering material disposed in said space.
